(19) United States
(12) Patent Application Publication
(10) Pub. No.: US 2006/0232366 A1
(43) Pub. Date: Oct. 19, 2006

(54) Over-current actuated reed relay and electrical outlet incorporating the same for providing over-current alarm

(76) Inventor: Jianshing Li, Tao yuan Hsien (TW)

Correspondence Address: BACON & THOMAS, PLLC, 625 SLATERS LANE, FOURTH FLOOR, ALEXANDRIA, VA, 22314, US

(21) Appl. No.: 11/402,912

(22) Filed: Apr. 13, 2006

(30) Foreign Application Priority Data
Apr. 15, 2005 (TW) 094205889
Mar. 8, 2006 (TW) 095203879

(51) Int. Cl. H01H 1/66

(52) U.S. Cl. 335/151

(57) ABSTRACT

An electrical outlet for supplying electrical power to one or more loads is provided with a reed relay, an alarm indicator, one or more receptacles, and a pair of input terminals connected to power source to provide power to the one or more receptacles. The reed relay comprises a reed switch and a coil around the reed switch. The coil is coupled between one of the two input terminals and the one or more receptacles and configured so that the coil can generate a sufficient magnetic field to drive the reed switch to actuate the alarm indicator to give an over-current warning to a user of the electrical outlet when total amount of current flowing through the coil and consumed by the one or more loads connected to the one or more receptacles exceeds a predetermined level of current.

### FIELD OF THE INVENTION

The present invention relates to electrical outlets and particularly, to an electrical outlet with unique reed relays that are operated to actuate an alarm indicator for providing over-current alarm.

### BACKGROUND OF THE INVENTION

FIG. 1 shows a prior art electrical outlet constructed as a 3-receptacle power strip, which comprises an upper housing half 10a and a lower housing half 10b attached to each other by screws 15a. Two copper bus bars 11a are fixed on lower housing half 10b by screws 12a and each of the bus bars is connected to power supply wires 14a at one end using fastening screws 13a, respectively. Such outlet does not have over-current alarm, and therefore a user uses the outlet without knowing whether there exists overload. If the outlet overloads, it can overheat, which can cause a potential shock or fire hazard.

There is, therefore, a need for an electrical outlet that indicates whether the total loads connected to the outlet is below rated load limit or provides an overload alarm when it overloads.

### SUMMARY OF THE INVENTION

In accordance with this invention, an electrical outlet for providing over-current alarm is provided. The electrical outlet includes at least one electrical receptacle, a pair of input terminals connected to the receptacle, a reed relay, and an alarm indicator. The reed relay includes a reed switch and a coil around the reed switch. The coil is coupled between one of the two input terminals and the receptacle. The reed switch is coupled to the alarm indicator. When the total current consumed by the loads connected to the outlet exceeds a predetermined level of current set to actuate the reed switch, the coil generates a sufficient magnetic field to drive the reed switch so as to actuate the alarm indicator to give a warning to a user.

According to the invention, the coil of the relay is made from a conductive wire that can carry large electrical power as carried by the input terminals so that it can carry the total amount of current flowing therethrough and generates a sufficient magnetic field to drive the reed switch when the total amount of current consumed by the loads exceeds a predetermined level such as the rated limit of current of the outlet. As the wire forming the coil can carry relatively large current, very few numbers of turns of coil around the reed switch would be required, for example, from less than one turn to a few turns, the impedance at the two ends of the coil is very low and heat generated due to eddy current may be ignored.

Preferably, the reed switch is of normally open type (Form “a” contacts). An insulating sleeve may be provided wrapping around the reed switch for protection purpose while the coil is fitted around the sleeve. In another embodiment, the coil is made of bare conductive wire and an insulating bushing is provided wrapping around the coil for shielding magnetic interference.

In accordance with this invention, the electrical outlet may be embodied in the form as a power outlet having a switch, a three-outlet adaptor, a wall outlet or a floor outlet.

The reed switch is coupled to the alarm indicator. When the total current consumed by the loads connected to the outlet exceeds a predetermined level of current set to actuate the reed switch, the coil generates a sufficient magnetic field to drive the reed switch so as to actuate the alarm indicator to give a warning to a user.

The invention also provides a reed relay comprising a reed switch and a coil around the reed switch. The coil is coupled to one or more loads. The coil is made from a conductive wire that can carry total amount of current consumed by all the loads connected so that the coil can generate a sufficient magnetic field to drive the reed switch when the total amount of current consumed by the loads exceeds a predetermined level. As very few numbers of turns of coil around the reed switch would be required, for example, from less than one turn to a few turns, the impedance thereof is very low and the operation of loads connected to the coil would not be affected.

### BRIEF DESCRIPTION OF THE DRAWINGS

This invention will become better understood by reference to the following detailed description, when taken in conjunction with the accompanying drawings, wherein:

FIG. 1 is a perspective view of a prior art electrical outlet for an extension cord, with a cover of the outlet detached.

FIG. 2 is a block diagram of an electrical outlet formed in accordance with the invention.

FIG. 3 is a perspective view of an electrical outlet for an extension cord formed in accordance with the invention, with a cover of the outlet detached.

FIG. 4 is an exploded perspective view of the electrical outlet of FIG. 2.

FIG. 5A is an enlarged perspective view of a reed relay used in the outlet of FIG. 3, formed in accordance with the invention.

FIG. 5B is an exploded enlarged perspective view of the reed relay of FIG. 5A.

FIG. 6 is a block diagram of an electrical outlet with two alarm indicators formed in accordance with the invention.

FIG. 7 is a block diagram of an electrical outlet with two alarm indicators and a switch formed in accordance with the invention.

FIGS. 8A-8D show a variety of electrical outlets having over-current alarm indicators formed in accordance with the invention.

FIGS. 9A-10B show perspective views of two alternative embodiments of reed relay of the invention.

FIG. 11 is a longitudinal sectional view of an alternative embodiment of a reed relay of the invention.

FIG. 12 is a circuitry with over-current protection in accordance with the invention.

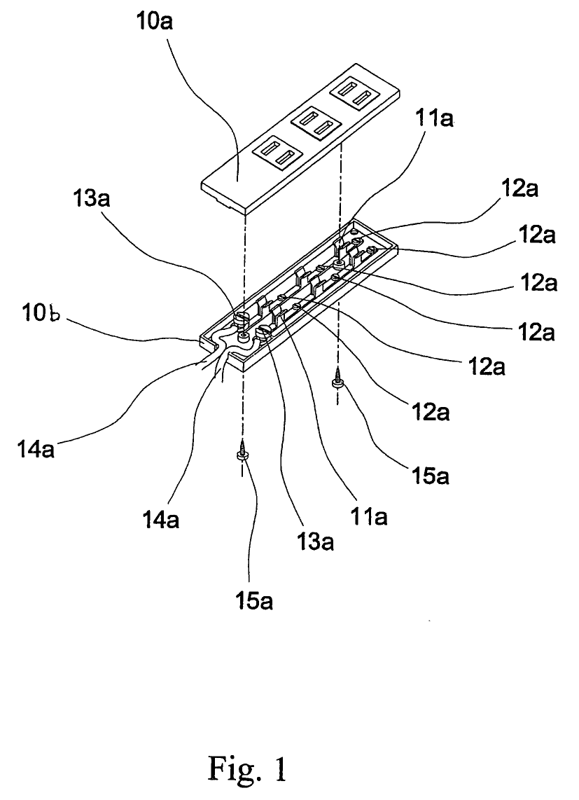

### DETAILED DESCRIPTION OF THE PREFERRED EMBODIMENT

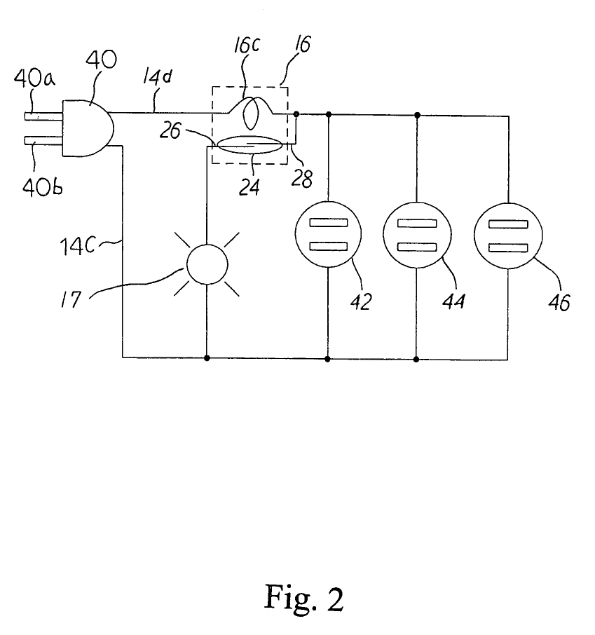

FIG. 2 is a block diagram of an electrical outlet formed in accordance with this invention. The electrical outlet includes a plug 40 having first and second input terminals 40a, 40b connected to power supply wires 14d and 14c, respectively, a reed relay 16 having normally open reed contacts (Form “a” contact), an alarm indicator 17, and three receptacles 42, 44, 46 in parallel relation. The relay 16 includes a reed switch 24 and a coil 16c. It is a characteristic of the invention that the coil 16c is coupled between the wire 14d (first terminal 40a) and the receptacles 42, 44, 46. The reed switch 24 has its two leads 28, 26 coupled between the wire 14d (first terminal 40a) and an alarm indicator 17, which in turn, is coupled to the wire 14c (second terminal 40b). Electrical power is applied across the input terminals 40a, 40b. The number of turns of the coil 16c of the relay 16 is chosen based on factors including gauge of coil wire (diameter), the rated current of the electrical outlet, predetermined amount of current for actuating the reed switch 24, and the sensitivity of the reed switch 24. When the total amount of current flowing through the coil 16c, the same as the total amount of current flowing through receptacles 42, 44, 46 and the loads connected to the receptacles 42, 44, 46, exceeds a predetermined level (e.g., the rated limit of the electrical outlet), the coil 16c generates a sufficient magnetic field to cause the reed contacts of the reed switch 24 to a closed-circuit position, allowing current to flow between the terminal 40a and alarm indicator 17. The alarm indicator then provides an indication of over-current condition.

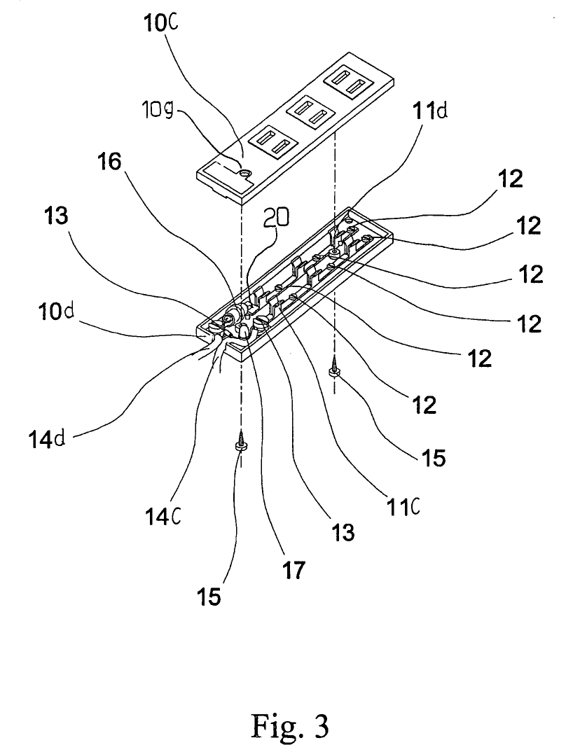

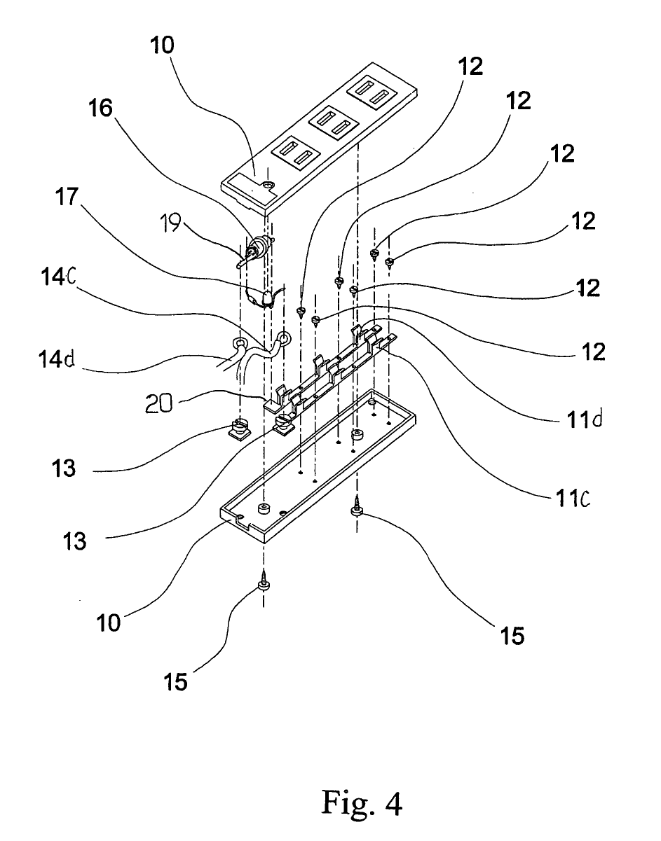

FIGS. 3 and 4 show an electrical outlet constructed as a 3-receptacle power strip with over-current alarm indicator, formed in accordance with this invention. A unique reed relay 16 is provided in the electrical outlet and is configured to actuate an alarm indicator 17 in response to an over-current state. The electrical outlet comprises an upper housing half 10c and a lower housing half 10d attached to each other by screws 15. Two copper bus bars 11c, 11d having 3 plug-receiving receptacles that may be connected to a plurality of loads are fixed on lower housing half 10d by screws 12.

A power supply wire 14c is electrically connected to bus bar 11c at one end using a screw 13. A conductive coil around a reed switch of the reed relay 16 is coupled between another power supply wire 14d and an end 20 of bus bar 11d, as described below.

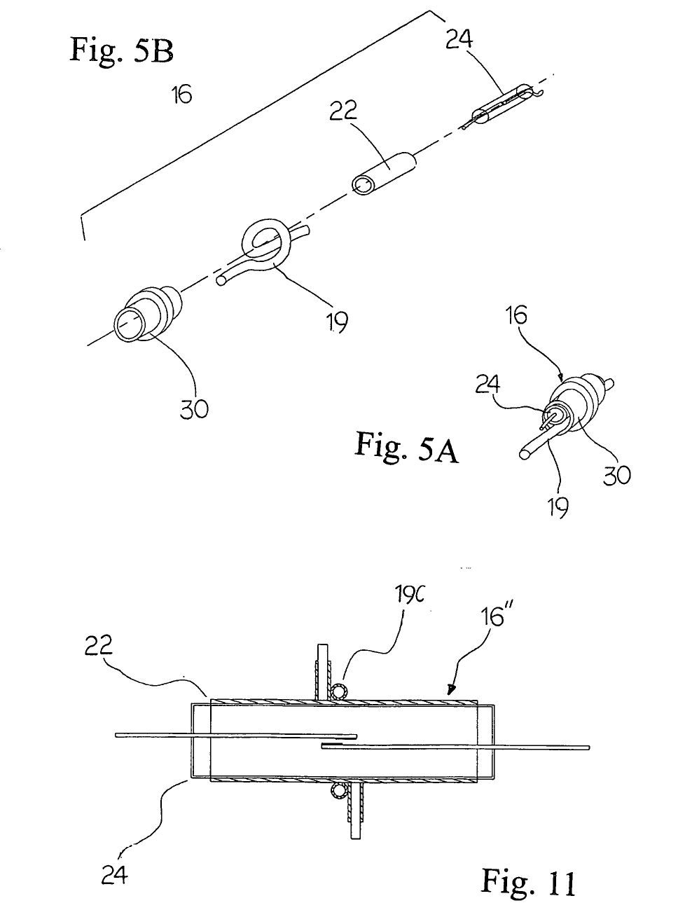

As shown in FIGS. 5A and 5B, reed relay 16 includes a reed switch 24 having a pair of normally open contacts (Form “a” contacts) in a glass envelope and two leads. Preferably, an insulating sleeve 22 is wrapped around reed switch 24 for protection purpose. A coil 19 of about one turn is provided around the reed switch 24. In this embodiment, the coil 19 is made of bare conductive wire, and preferably, an insulating bushing 30 wrapping the coil is provided for shielding magnetic interference.

As shown in FIGS. 3 and 4, one of the two leads of reed switch 24 of the reed relay 16 is connected to the end 20 of bus bar 11d through soldering, crimping or well known means. The other lead is connected to one of the two terminals of alarm indicator 17, and the other terminal of alarm indicator 17 is connected to the common connection end of wire 14c and bus bar 11c where they are tightened by the screw 13.

Preferably, the indicator 17 is a light-emitting diode (LED). The upper housing half 10c may be provided with a hole 10g or other means to allow viewing of the LED, as shown in FIG. 3. Alternatively, upper housing half 10c may be made from transparent or semi-transparent material, saving the provision of hole 10g.

According to the invention, coil 19 of the relay 16 is made from a conductive wire that can carry large electrical power as carried by wire 14d so that it can carry the total amount of current flowing through wire 14d. Besides, the number of turns of coil 19 is so selected that the coil can generate a sufficient magnetic force to drive the reed contacts of the reed switch to a closed-circuit position, allowing current to energize the alarm indicator. As very few numbers of turns of coil 19 around the reed switch 24 would be required according to the invention, the impedance thereof is very low and heat generated due to eddy current may be ignored.

The operation of the reed relay of the invention is described below. The coil of the reed relay is coupled between the input terminal of the electrical outlet and the loads connected to the outlet in series relation. The total current consumed by the loads connected to the receptacles of the outlet would flow through the coil of selected number of turns before flowing through the loads. Thus, it is possible to set a level of current (e.g., a value close to or equal to the rated limit of the electrical outlet) and the number of turns of the coil. When total amount of current consumed by the loads exceeds the predetermined level of current, the coil generates a sufficient magnetic force to drive the reed contacts of the reed switch so as to actuate an alarm indicator to give warning to a user.

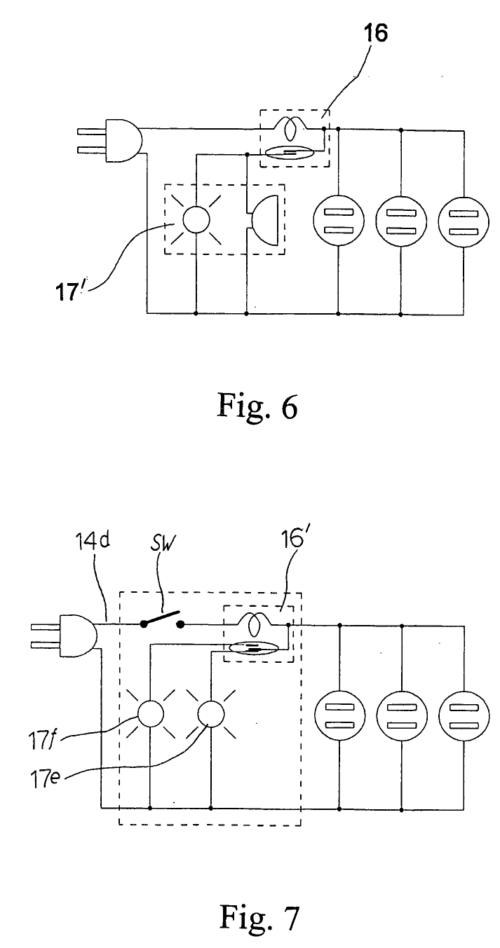

FIG. 6 shows a block diagram of an electrical outlet formed in accordance with a further embodiment of this invention. This block diagram is the same as that shown in FIG. 2 except that an alarm indicator 17′ including a visible alarm device 17a and an audible alarm device 17b in parallel relation.

FIG. 7 shows a block diagram of an electrical outlet formed in accordance with a further embodiment of this invention. This block diagram differs from that shown in FIG. 2 in that a switch SW is coupled between an input terminal connected to wire 14d and a reed relay 16′ to control whether current should be supplied to receptacles of the outlet. Further, the reed relay 16′ has a reed switch of Form “c” contacts, where a normally-closed circuit will supply current to a visible alarm indicator 17e, such as green LED, showing normal operation of the outlet, and a normally-open circuit will supply current to a visible alarm indicator 17f, such as red LED, showing over-current state when the reed relay is actuated by a predetermined current level.

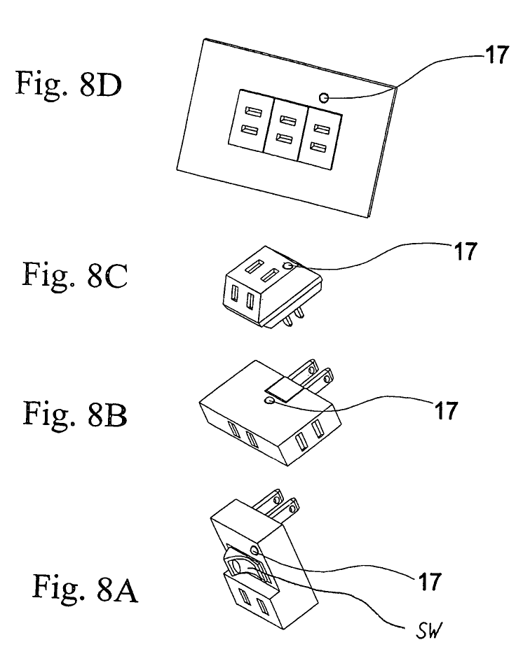

Although the reed relay and alarm indicator have been described as being provided in an electrical outlet for extension cord, those skilled in the art will recognize that they may be applied to various forms of electrical outlets, power switches or circuitries. As illustrated in FIGS. 8A to 8D, an electrical outlet according to the invention may embodied in the form as a power outlet having a switch (SW) (FIG. 8A), a swivel outlet adaptor (FIG. 8B), a three-outlet adaptor (FIG. 8C), and a wall outlet (FIG. 8C). All these outlets have alarm indicators 17 in association with a reed relay (not shown) according to this invention. The outlet having a switch as shown in FIG. 8A may incorporate the block diagram shown in FIG. 7.

Many changes to the invention will become apparent to those skilled in the art. For example, although a sleeve 22 is around the reed switch 24 shown in the above-described embodiment, it may be omitted if desired. Besides, the coil 19 may be glued onto the reed switch 24 by adhesive or other well known means.

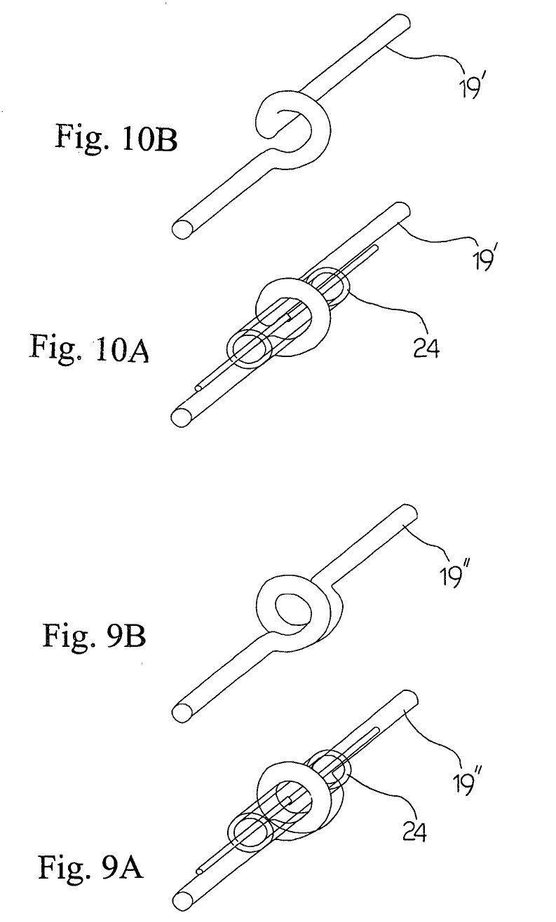

Further, it is possible that the coil 19 of the reed relay is formed by winding a part of the end of the wire 14d. Alternatively, the coil may be formed from a conductive wire of greater gauge that can carry more power than wire 14d. The number of turns of the coil depends on the sensitivity of reed switch contacts, predetermined current level for driving the reed switch, and gauge of the wire (diameter). Therefore, the number of turns of the coil may be more or less than one turn. For example, FIG. 9A shows an alternative embodiment of a reed relay of the invention having reed switch 24 and a coil 19″. The number of turn of the coil 19″ is just slightly more than one turn, as shown in FIG. 9B. On the other hand, FIGS. 10A and 10B show an alternative embodiment of a reed relay of the invention having reed switch 24 and a coil 19′ with the number of turn of the coil slightly less than one turn.

According to an example of a reed relay of the invention, for an electrical outlet with rated limit of 110V, 15 A (1650 W), a reed switch with part No. MN2S1520 (normally open, Form “a”) available from SRC Devices Inc., U.S.A. is used. 9/10 turn of bare copper wire of 1.6 mm diameter is provided around the reed switch to form a reed relay that can be actuated when there is over-current condition, as shown in FIG. 5B.

FIG. 9A shows an alternative embodiment of a reed relay of the invention indicated by reference numeral 16″, which has reed switch 24 (Form “a” contacts) received in a sleeve 22, and a coil 19c around the switch. As the coil is formed from enameled wire, the bushing 30 shown in FIG. 5B may be unnecessary.

Those skilled in the art will appreciate that the electrical outlet and reed switch of this invention can be used on alternate or direct circuit. The alarm indicator (17, 17′) may be visible or audible device (e.g. a buzzer) or both. Other methods may be used to connect the wires from the first power cable 64 to the managed electrical outlet 50.

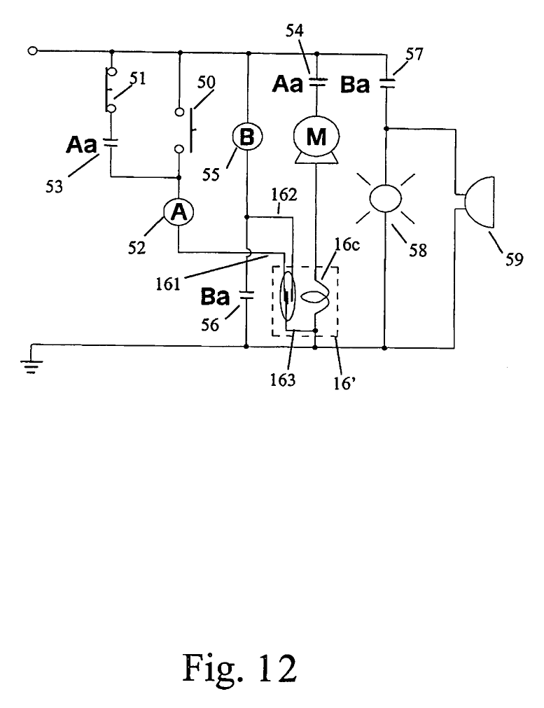

FIG. 12 shows an embodiment of a circuit with over-current protection according to the invention. Once a pushbutton switch 50 is depressed, current flows through a coil 52 of a relay A and terminals 161, 163 of a normally closed contacts of a reed relay 16′, and the coil 52 is excited, causing the normally open contacts 53, 54 (Form “a” contacts) to a closed-circuit position. Upon release of the switch 50, current flows through switch 51, a contact 53 at closed-circuit position, and the coil 52 of the relay A, maintaining the excitation of coil 52, i.e., a self-holding circuit being established by relay A. Thus, the contact 54 remains at closed-circuit position and current flows to load M and coil 16c of reed relay 16′, energizing the load M.

When load M overloads, the overload current flowing through coil 16c energies relay 16′ to drive the normally closed contact terminals 161, 163 to an open-circuit position. Thus, coil 52 is no longer excited and contacts 53, 54 return to open-circuit position. Load M ceases to operate due to no current flowing through the load and coil 16c. On the other hand, when normally closed contact terminals 161, 163 of reed relay 16′ are driven to an open-circuit position, normally open contact terminals 162, 163 of reed relay 16′ become at closed-circuit position, allowing current to flow through coil 55 of relay B to excite the coil 55. Thus, the normally open contacts 56, 57 are driven to a closed-circuit position, allowing current to flow through the contact 56 at closed-circuit position and the coil 55 of the relay B, maintaining the excitation of coil 55, i.e., a self-holding circuit being established by relay B, although normally open contact terminals 162, 163 return to open-circuit position due to no current flowing through coil 16c. Accordingly, contacts 56, 57 remain at closed-circuit position and a visible alarm indicator 58 and an audible alarm indicator 59 operate to give alarm.

As can be seen from the above, the reed relay of the invention can be used as a quick response over-current sensing device that is simple and reliable, and can be incorporated in an electrical outlet for providing over-current alarm or in a circuitry for providing over-current protection.

While the preferred embodiment of the invention has been illustrated and described, it will be appreciated that various changes can be made therein without departing from the spirit and scope of the invention.

What is claimed is:

1. An electrical outlet for supplying electrical power to one or more loads, comprising:
one or more receptacles;
a pair of input terminals connected to power source to provide power to the one or more receptacles;
a reed relay comprising:
a reed switch, and
a coil having predetermined number of turns around the reed switch and coupled between one of the two input terminals and the one or more receptacles; and
an alarm indicator coupled to the reed switch and configured to give an over-current warning to a user when actuated;
whereby the coil can generate a sufficient magnetic field to drive the reed switch to actuate the alarm indicator to give an over-current warning to a user of the electrical outlet when total amount of current flowing through the coil and consumed by the one or more loads connected to the one or more receptacles exceeds a predetermined level of current.

2. The electrical outlet of claim 1, wherein the predetermined number of turns of the coil is from less than one turn to a few turns such that the impedance at two ends of the coil is too low to affect the normal operation of the one or more loads.

3. The electrical outlet of claim 2, wherein the coil is made from a conductive wire of a gauge and impedance that can carry total amount of current carried by the input terminals and flowing through the one or more receptacles.

4. The electrical outlet of claim 1, wherein the alarm indicator may be visible or audible alarm indicator, or the combination of both.

5. The electrical outlet of claim 1, wherein the electrical outlet may be embodied in the form as a three-outlet adaptor, a power outlet having a switch, an outlet for an extension cord, a wall outlet or a floor outlet.

6. A reed relay, comprising a reed switch and a coil of predetermined number of turns around the reed switch, the coil coupled to one or more loads in series relation so as to generate a sufficient magnetic field to drive the reed switch when total amount of current consumed by the one or more loads exceeds a predetermined level.

7. The reed relay of claim 6, wherein the predetermined number of turns of the coil around the reed switch is from less than one turn to a few turns such that the impedance at two ends of the coil is too low to affect the normal operation of the one or more loads.

8. The reed relay of claim 7, wherein the coil is made from a conductive wire of a gauge and impedance that can carry total amount of current flowing through the one or more loads.

9. The reed relay of claim 8, wherein an alarm indicator is coupled to the reed switch and wherein the one or more loads applied to an electrical outlet, a power switch or a circuitry, and wherein the predetermined level is the rated limit of the electrical outlet, the power switch or the circuitry, whereby the coil can generate a sufficient magnetic field to drive the reed switch to protect the loads or to actuate the alarm indicator to give a warning when total amount of current flowing through the coil exceeds the predetermined level.

10. The reed relay of claim 9, further comprising a sleeve provided between the coil and the reed switch.

11. A reed relay for use with an electrical outlet for supplying electrical power to one or more loads, the electrical outlet comprising:
one or more receptacles; a pair of input terminals connected to power source to provide power to the one or more receptacles; the reed relay comprising:
a reed switch, and
a coil of predetermined number of turns around the reed switch and coupled between one of the two input terminals and the one or more receptacles;
whereby the coil can generate a sufficient magnetic field to drive the reed switch when total amount of current flowing through the coil and consumed by the one or more loads connected to the one or more receptacles exceeds a predetermined level of current.

12. The reed relay of claim 11, wherein the predetermined number of turns of the coil is from less than one turn to a few turns such that the impedance at two ends of the coil is too low to affect the normal operation of the one or more loads.

13. The reed relay of claim 12, wherein the coil is made from a conductive wire of a gauge and impedance that can carry total amount of current carried by the input terminals and consumed by the one or more loads connected to the one or more receptacles.
